(19) United States
(12) Patent Application Publication
(10) Pub. No.: US 2003/0211193 A1
(43) Pub. Date: Nov. 13, 2003

(54) Device for processing thermoplastic materials

(76) Inventors: Boris Timoshevsky, Mikolaev (UA); Mikhailo Tkach, Mikolaev (UA); Victor Bozhenar, Kiev (UA)

Correspondence Address: Ilya Zborovsky, 6 Schoolhouse Way, Dix Hills, NY, 11746, US

(21) Appl. No.: 10/142,985

(22) Filed: May 10, 2002

(51) Int. Cl. B29C 35/02

(52) U.S. Cl. 425/340; 422/234; 422/238; 422/232

(57) ABSTRACT

A device for processing thermoplastic materials has a melting unit for melting an initial thermoplastic material and forming a flow of liquid thermoplastic material, a pyroliser for processing the liquid thermoplastic material by pyrolysis, an element for connecting the melting unit with the pyroliser, an element for withdrawing from the pyroliser products of pyrolysis, and an element for recirculating at least a part of products of pyrolysis back into the pyroliser.

### BACKGROUND OF THE INVENTION

The present invention relates generally to devices for processing thermoplastic materials, for examples wastes of thermoplastic materials such as polyolifines, polyethylene, polypropylene, polysterene and their copolymers, to produce pyrolysis gas and/or liquid fuel.

Devices for processing of thermoplastic materials with the use of pyrolysis are known, for example in “Applied Pyrolysis Handbook” Thomas P. Wampler, New York, M. Dekker 1995. A device for processing raw polymeric material to produce a liquid fuel with the use of pyrolysis is also disclosed in Y. Sakataa, et al, “Catalitic Degradation of Polyethylene Into Fuel Oil Over Mesoporous Silica (KFS-16)” Catalist, Journal of Analytical and Applied Pyrolysis, Vol. 43, 1997, pp 15-25. Finally, a device for producing of polymers is disclosed in Y. Kaminsky, et al “Thermal Degradation of Mixed Plastic Waste to Aromatics and Gas”, Polymer Degradation and Stability, Vol. 53, 1996, pp 189-197.

The known devices include a melting unit with an inlet for loading a solid thermoplastic material and an outlet for discharging a melted material, a pump for pumping the melted material, and pyroliser into which the melting material is supplied for pyrolysis processing and from which products of the pyrolysis are withdrawn. The known devices are characterized by a relatively low efficiency, high energy consumption, and insufficient thermal degradation of the thermoplastic materials.

### SUMMARY OF THE INVENTION

Accordingly, it is an object of the present invention to provide a device for processing thermoplastic materials which avoids the disadvantages of the prior art.

In keeping with these objects and with others which will become apparent hereinafter, one feature of present invention resides, briefly stated, in a device for processing of thermoplastic materials which includes a melting unit for melting an initial thermoplastic material and forming a flow of liquid thermoplastic material; a pyroliser for processing of the liquid thermoplastic material by pyrolysis; means for connecting the melting unit with the pyroliser; means for withdrawing from the pyroliser products of pyrolysis; and means for recirculating at least a part of products of pyrolysis back into the pyroliser.

When the device is designed in accordance with the present invention, the degree of thermal destruction of a polymeric raw material is substantially increased, the quality of liquid fuel is increased, the energy consumption is reduced.

The novel features which are considered as characteristic for the present invention are set forth in particular in the appended claims. The invention itself, however, both as to its construction and its method of operation,-together with additional objects and advantages thereof, will be best understood from the following description of specific embodiments when read in connection with the accompanying drawings.

### BRIEF DESCRIPTION OF THE DRAWINGS

FIG. 1 of the drawings shows a device for processing of thermoplastic materials in accordance with a first embodiment of the present invention; and

FIG. 2 is a view showing a device for processing of thermoplastic materials in accordance with a second embodiment of the present invention.

### DESCRIPTION OF PREFERRED EMBODIMENTS

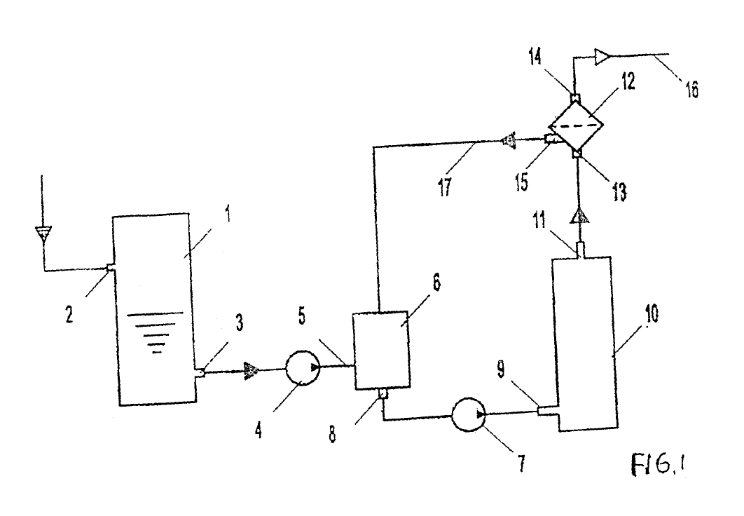

The device for processing of thermoplastic materials, for example wastes of thermoplastics, in accordance with one embodiment is shown in FIG. 1. The device has a melting unit i provided with an inlet pipe 2 and an outlet pipe 3. A pump 4 is provided for transporting of a melted thermoplastic material and has an inlet connected to the outlet pipe 3 of the melting unit I and an outlet connected with a pipeline 5 for supplying the melted material. A buffer container 6 as well as a recirculating pump 7 are arranged in the pipeline 5. The recirculating pump 7 has an inlet connected with an outlet pipe 8 of the buffer container 6, and an outlet connected to a pipe 9 of a pyroliser 10. The pyroliser 10 has an outlet pipe 11 for discharging of pyrolysis products. The outlet pipe 11 is connected with an inlet pipe 13 of a separator 12. The separator 12, in turn, has an outlet pipe 14 for discharging gas and an outlet pipe 15 for discharging liquid. The outlet pipe 14 discharging gas is connected to a consumer pipeline 16. The outlet pipe 15 for discharging liquid is connected by a recirculating pipe 17 to the buffer container 6.

The device operates in the following manner. A solid plastic material is loaded through the pipe 2 into an inner space of the melting unit 1, in which it is melted in a known manner. The flow of melted thermoplastic material flows through the pipe 3 to the pump 4, and then is supplied by the pump 4 to the pipeline 5 through which it is supplied to the buffer container 6. The recirculating pump 7 supplies the liquid flow of thermoplastic material from the outlet pipe 8 of the buffer container 6 to the inlet pipe 9 of the pyroliser 10. The thermal processing of the liquid thermoplastic material is performed in the pyroliser 10 and products of pyrolysis are produced. Mixture of pyrolysis gas with drops of liquid thermoplastic material and products of their incomplete thermal degradation is supplied from the pyroliser 10 through the outlet pipe 11 to the inner pipe 13 of the separator 12. In the separator a separation of the pyrolysis products is performed. A separated liquid mixture of the thermoplastic materials and the products of their incomplete thermal degradation are supplied through the outlet pipe 15 of the separator 12 into the recirculating pipe 17 and returned into the buffer container 6. The produced pyrolysis gas flows through the outlet pipe 14 from the separator 12 to the consumer pipeline 16.

The buffer container, the recirculating pump and the separator together with the recirculating pipe form an auxiliary circulating contour to reduce energy consumption, which in turn provides the improvement of heat exchange in the pyroliser due to the increase of speed of movement of liquid, and also increases the degree of thermal degradation of the thermoplastic material due to the increase of time of contact of the thermoplastic materials with heated surfaces of heat exchange.

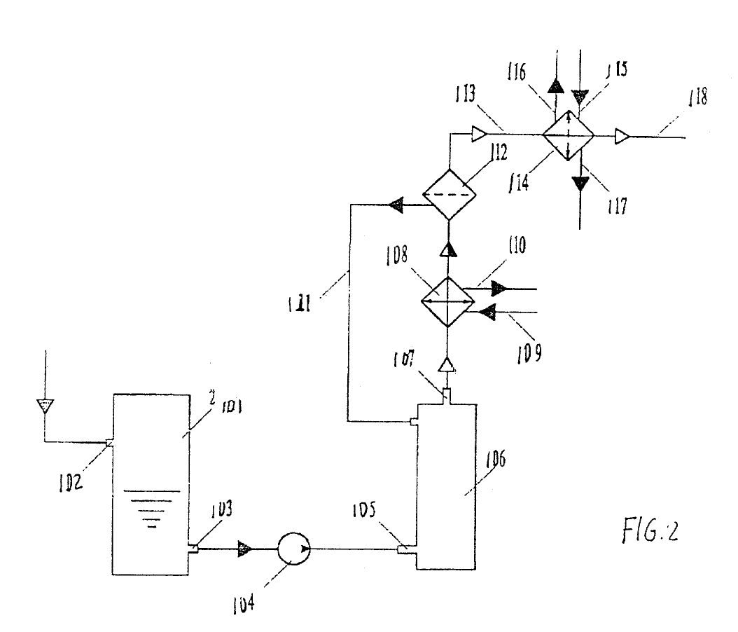

The device for producing thermoplastic materials in accordance with another embodiment of the present invention is shown in FIG. 2. The device has a melting unit 101 with an inlet pipe 102 for supplying a polymeric raw material and an outlet pipe 103 connected with a pump 104. The outlet of the pump 104 is connected with an inlet pipe 105 of a pyroliser or pyrolising reactor 106. The outlet pipe 107 of the pyroliser is connected to an auxiliary condenser 108 which has an inlet pipe 109 for supplying a cooling heat exchange medium and an outlet pipe 110 for withdrawing the cooling heat exchange medium. A separator 112 is located after the auxiliary condenser 108 and is connected with the pyroliser 106 by a return conduit 111.

The separator 112 is connected by a pipe 113 for supplying pyrolysis gas to a main condenser 114. The main condenser 114 has an inlet pipe 115 for supplying a cooling liquid and an outlet pipe 116 for withdrawing the cooling liquid. It also has an outlet pipe 117 for withdrawal of a useful product-liquid fuel, and an outlet pipe 118 for withdrawal of a gas which did not condense to a consumer.

The device shown in FIG. 2 operates in the following manner. Polymeric raw material is supplied through the pipe 102 into the melting unit 101 in which it is melted under the action of supplied outside energy, for example by burning of a part of pyrolysis gas or liquid fuel. The melted polymeric material is supplied through the pipe 103 to the pump 104, which pumps the polymeric liquid through the pipe 105 into the pyroliser 106. Pyrolysis of the liquid polymeric material is performed in the pyroliser 106 without air supply with the use of an outlet energy source (analogously to the melting unit). Gases produced in the pyroliser are supplied through the pipe 107 to the auxiliary condenser 108, in which the products of partial pyrolysis and high molecular compounds are condensed from the useful product. The condenser 108 is cooled by a heat exchanging substance, for example polymethylsiloxaine liquid which is supplied through the pipe 109 and withdrawn through the pipe 110. The condensed liquid products of the partial pyrolysis and high molecular products mixed with gaseous useful products are supplied into the separator 112. In the separator 112 liquid is separated and returned through the return conduit 111 back to the pyroliser 106 for a secondary destruction. Therefore the high molecular products are not entrained into the composition of the liquid fuel and do not reduce its quality. The return of these products for the secondary pyrolysis increases the yield of the useful fuel by 25-35%.

The low molecular products of pyrolysis are supplied through the pipe 113 to the main condenser 114. In the main condenser, condensation of these products is performed with production of liquid fuel of a desired quality. The cooling of main condenser 114 is performed by water which is supplied through the pipe 115 and withdrawn through the pipe 116. Useful product or in other words the liquid fuel is withdrawn through the pipe 117. Hydrocarbon gases which are not condensed are withdrawn from the pipe 118 and can be used as energy carrier in the same device.

The use of the auxiliary condenser-separator makes possible a separation of partial pyrolysis and high molecular compounds and their return through the return pipe to the pyroliser for the secondary thermal destruction. As a result the quality and quantity of the useful product or in other words the liquid fuel is increased. Also, energy consumption for obtaining the useful product is reduced since the secondary destruction of products of partial pyrolysis and high molecular compositions is performed in the same reactor without additional heat.

It will be understood that each of the elements described above, or two or more together, may also find a useful application in other types of constructions differing from the types described above.

While the invention has been illustrated and described as embodied in device for producing thermoplastic materials, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for processing thermoplastic materials, comprising a melting unit for melting an initial thermoplastic material and forming a flow of liquid thermoplastic material; a pyroliser for processing of the liquid thermoplastic material by pyrolysis; means for connecting said melting unit with said pyroliser; means for withdrawing from said pyroliser products of pyrolysis; and means for recirculating at least a part of products of pyrolysis back into said pyroliser.

2. A device as defined in claim 1; and further, comprising a pipeline connecting said melting unit with said pyroliser; and a buffer container and a recirculating pump located in said pipeline, said recirculating pump having an inlet connected with said buffer container and an outlet connected to said pyroliser, said pyroliser having an outlet connected with an inlet of said buffer container.

3. A device as defined in claim 2; and further comprising a separator for separating a liquid produced by said pyrolysis, said separator having an inlet connected with said outlet of said pyroliser and an outlet connected with said inlet of said buffer container, said separator also having a further outlet for withdrawning the gas produced by the pyrolysis, to a consumer.

4. A device as defined in claim 1; and further comprising a main condenser located downstream of said pyroliser and condensing products of the pyrolysis for producing a liquid fuel; and an auxiliary condenser connected with said pyroliser and said main condenser and condensing products of partial pyrolysis and high molecular compositions, said auxiliary condenser having an inlet connected with an outlet of said pyroliser and an outlet connectable to an inlet of said main condenser.

5. A device as defined in claim 4; and further comprising a separator located between said condensers for separating a liquid produced by the pyrolysis and returning the liquid back to said pyroliser.

6. A device as defined in claim 5; and further comprising a return pipe connecting an outlet of said separator with an inlet of said pyroliser.

7. A device as defined in claim 6, wherein said separator has a further outlet connected with said inlet of said main condenser and an inlet connected with said outlet of said auxiliary condenser.

8. A device as defined in claim 1; and further comprising a pump provided between said melting unit and said pyroliser and pumping flow of liquid thermoplastic material from said melting unit to said pyroliser.
